(19) United States
(12) Patent Application Publication
(10) Pub. No.: US 2013/0088978 A1
(43) Pub. Date: Apr. 11, 2013

(54) Joint Encoding of Rank and CQI Feedback For Comp

(71) Applicants: Bishwarup Mondal, Schaumburg, IL (US); Eugene Visotsky, Buffalo Grove, IL (US)

(72) Inventors: Bishwarup Mondal, Schaumburg, IL (US); Eugene Visotsky, Buffalo Grove, IL (US)

(73) Assignee: Nokia Siemens Networks Oy

(21) Appl. No.: 13/268,298

(22) Filed: Oct. 7, 2011

(51) Int. Cl. H04W 4/06; H04W 24/00

(52) U.S. Cl. 370/252; 370/312

(57) ABSTRACT

A method to reduce feedback overhead for CoMP operation is described. The method includes deriving a set of CSI for a coordinated multi-point transmission received at a UE over a plurality of radio links Each CSI of the set of CSI pertains to a radio link of the plurality of radio links. The plurality of radio links includes a first link from a serving transmission point and at least one multi-point link from at least one non-serving transmission point to the UE. The method also includes jointly encoding at least two CSI from the set of CSI. Apparatus and computer readable media are also described.

### TECHNICAL FIELD

The exemplary and non-limiting embodiments of this invention relate generally to wireless communication systems, methods, devices and computer programs and, more specifically, relate to providing channel state information for multiple radio links in coordinated multi-point transmission.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

3GPP third generation partnership project

CDM code division multiplexing

CoMP coordinated multi-point

CQI channel quality indicator

CSI channel state information

DL downlink (eNB towards UE 210)

eNB E-UTRAN Node B (evolved Node B)

EPC evolved packet core

E-UTRAN evolved UTRAN (LTE)

HARQ hybrid automatic repeat request

LTE long term evolution of UTRAN (E-UTRAN)

MAC medium access control (layer 2, L2)

MM/MME mobility management/mobility management entity

Node B base station

O&M operations and maintenance

OFDMA orthogonal frequency division multiple access

PDCP packet data convergence protocol

PDSCH physical downlink shared channel

PHY physical (layer 1, L1)

PMI precoding matrix indicator

PUCCH physical uplink control channel

PUSCH physical uplink shared channel

RI rank indication

RLC radio link control

RRC radio resource control

RRM radio resource management

SC-FDMA single carrier, frequency division multiple access

S-GW serving gateway

SINR signal to interface plus noise ratio

SRS sounding reference signal

UE 210 user equipment, such as a mobile station or mobile terminal

UL uplink (UE 210 towards eNB)

ULA uniform linear array

UTRAN universal terrestrial radio access network

A communication system known as evolved UTRAN (E-UTRAN, also referred to as UTRAN-LTE or as E-UTRA) has been specified within 3GPP. The DL transmission technique is OFDM, and the UL access technique is SC-FDMA.

One specification of interest is 3GPP TS 36.300, V10.4.0 (2011-June), “3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 10)”, incorporated by reference herein in its entirety.

FIG. 1 reproduces FIG. 4-1 of 3GPP TS 36.300, and shows the overall architecture of the E-UTRAN system. The E-UTRAN system includes eNBs, providing the E-UTRA user plane (PDCP/RLC/MAC/PHY) and control plane (RRC) protocol terminations towards the UE 210 (not shown). The eNBs are interconnected with each other by means of an X2 interface. The eNBs are also connected by means of an S1 interface to an EPC, more specifically to a MME (Mobility Management Entity) by means of a S1 MME interface and to a Serving Gateway (SGW) by means of a S1 interface. The S1 interface supports a many-to-many relationship between MMEs/S-GW and eNBs.

The eNB hosts the following functions:
functions for RRM: Radio Bearer Control, Radio Admission Control, Connection Mobility Control, Dynamic allocation of resources to UEs in both UL and DL (scheduling);
IP header compression and encryption of the user data stream;
selection of a MME at UE 210 attachment;
routing of User Plane data towards the Serving Gateway;
scheduling and transmission of paging messages (originated from the MME);
scheduling and transmission of broadcast information (originated from the MME or O&M); and
a measurement and measurement reporting configuration for mobility and scheduling.

Coordinated Multi-point (CoMP) transmission is currently being investigated in 3GPP RAN1. The motivation for CoMP is to allow fast coordination among different transmission points to improve throughput performance. To enable closed-loop transmission from multiple transmission points to a given UE 210, channel state information (CSI) for multiple radio links is measured by the UE 210 and sent to the network using an uplink control channel (PUCCH) or an uplink data channel (PUSCH).

A user equipment (UE 210) in a CoMP scenario may be attached to a serving eNB and communicates with that eNB for UL control (PUCCH), uplink data (PUSCH), DL control (PDCCH) channels. For CoMP transmission, the UE 210 can receive joint transmission (PDSCH) from the serving eNB and one or more non-serving eNBs.

The UE 210 may need to perform CSI measurements for each channel/link between the UE 210 and the various eNBs. The UE 210 then sends the measurements to the serving eNB via a PUCCH or a PUSCH. Under the current specifications, this would require at least n times the overhead compared to non-CoMP feedback (e.g., those for in single cell feedback with one link of interest) if CSI measurements corresponding to n links are needed to be sent to the eNB. However, this increase in overhead may be undesirable and unsustainable for practical CoMP operation.

Therefore, there is a need to reducing feedback overhead for CoMP operation.

One method for reducing feedback overhead includes the use of an inter-cell codebook. This implies that a PMI for a first radio link can be combined with a PMI for a second radio link by the inter-cell codebook to generate a PMI for a multi-point radio link of the two radio links. The advantage of hierarchical feedback is that, from a multi-cell PMI, individual single-cell PMIs can be deconstructed and therefore can provide a variety of scheduling options for the network. However, this approach does not target compression of feedback information; rather, it focuses on providing flexibility at the network.

Another method is to use non-hierarchical PMI feedback. In this approach, a single joint PMI is used for a multi-point radio link (e.g., between a serving eNB, a non-serving eNB and a UE 210) in addition to a single cell PMI for a radio link between the serving eNB and the UE 210. The ranks can be different for the component radio links of the multi-point radio link and there is compression of PMI information by using a joint PMI. This approach is limited to only PMI and does not apply to other constituents of CSI feedback, e.g., rank and CQI.

### SUMMARY

The below summary section is intended to be merely exemplary and non-limiting.

The foregoing and other problems are overcome, and other advantages are realized, by the use of the exemplary embodiments of this invention.

In a first aspect thereof an exemplary embodiment of this invention provides a method to reduce feedback overhead for CoMP operation. The method includes deriving a set of CSI for a coordinated multi-point transmission received at a UE over a plurality of radio links. Each CSI of the set of CSI pertains to a radio link of the plurality of radio links. The plurality of radio links includes a first link from a serving eNB to the UE and at least one multi-point link from the serving eNB and at least one non-serving eNB to the UE. The method also includes jointly encoding at least two CSI from the set of CSI.

In a further aspect thereof an exemplary embodiment of this invention provides an apparatus to reduce feedback overhead for CoMP operation. The apparatus includes at least one processor; and at least one memory including computer program code. The at least one memory and the computer program code are configured to, with the at least one processor, cause the apparatus to perform actions. The actions include to derive a set of CSI for a coordinated multi-point transmission received at a UE over a plurality of radio links Each CSI of the set of CSI pertains to a radio link of the plurality of radio links. The plurality of radio links includes a first link from a serving eNB to the UE and at least one multi-point link from the serving eNB and at least one non-serving eNB to the UE. The actions also include to jointly encode at least two CSI from the set of CSI.

In an additional aspect thereof an exemplary embodiment of this invention provides a computer readable medium to reduce feedback overhead for CoMP operation. The computer readable medium is tangibly encoded with a computer program executable by a processor to perform actions. The actions include deriving a set of CSI for a coordinated multi-point transmission received at a UE over a plurality of radio links. Each CSI of the set of CSI pertains to a radio link of the plurality of radio links. The plurality of radio links includes a first link from a serving eNB to the UE and at least one multi-point link from the serving eNB and at least one non-serving eNB to the UE. The actions also include jointly encoding at least two CSI from the set of CSI.

In a further aspect thereof an exemplary embodiment of this invention provides an apparatus to reduce feedback overhead for CoMP operation. The apparatus includes means for deriving a set of CSI for a coordinated multi-point transmission received at a UE over a plurality of radio links. Each CSI of the set of CSI pertains to a radio link of the plurality of radio links. The plurality of radio links includes a first link from a serving eNB to the UE and at least one multi-point link from the serving eNB and at least one non-serving eNB to the UE. The apparatus also includes means for jointly encoding at least two CSI from the set of CSI.

### BRIEF DESCRIPTION OF THE DRAWINGS

The foregoing and other aspects of exemplary embodiments of this invention are made more evident in the following Detailed Description, when read in conjunction with the attached Drawing Figures, wherein:

FIG. 1 reproduces FIG. 4-1 of 3GPP TS 36.300, and shows the overall architecture of the E UTRAN system.

FIG. 2 shows a simplified block diagram of exemplary electronic devices that are suitable for use in practicing various exemplary embodiments of this invention.

FIG. 3 shows a more particularized block diagram of an exemplary user equipment such as that shown at FIG. 2.

FIG. 4 shows a simplified block diagram of exemplary electronic devices that are suitable for use in practicing various exemplary embodiments of this invention.

FIG. 5 is a logic flow diagram that illustrates the operation of an exemplary method, and a result of execution of computer program instructions embodied on a computer readable memory, in accordance with various exemplary embodiments of this invention.

### DETAILED DESCRIPTION

Various exemplary embodiments in accordance with this invention provide for PUCCH/PUSCH reporting of CQI/RI (in the case of codebooks) or CQI (in the case of SRS) from a given UE 210 to a serving eNB. The reporting may include information pertaining to a plurality of radio links. These radio links may include links from the given UE 210 to other, non-serving eNBs. Some or all of the CQI/RI information may be jointly encoded across two or more radio links such that the reporting is more efficient in terms of payload size.

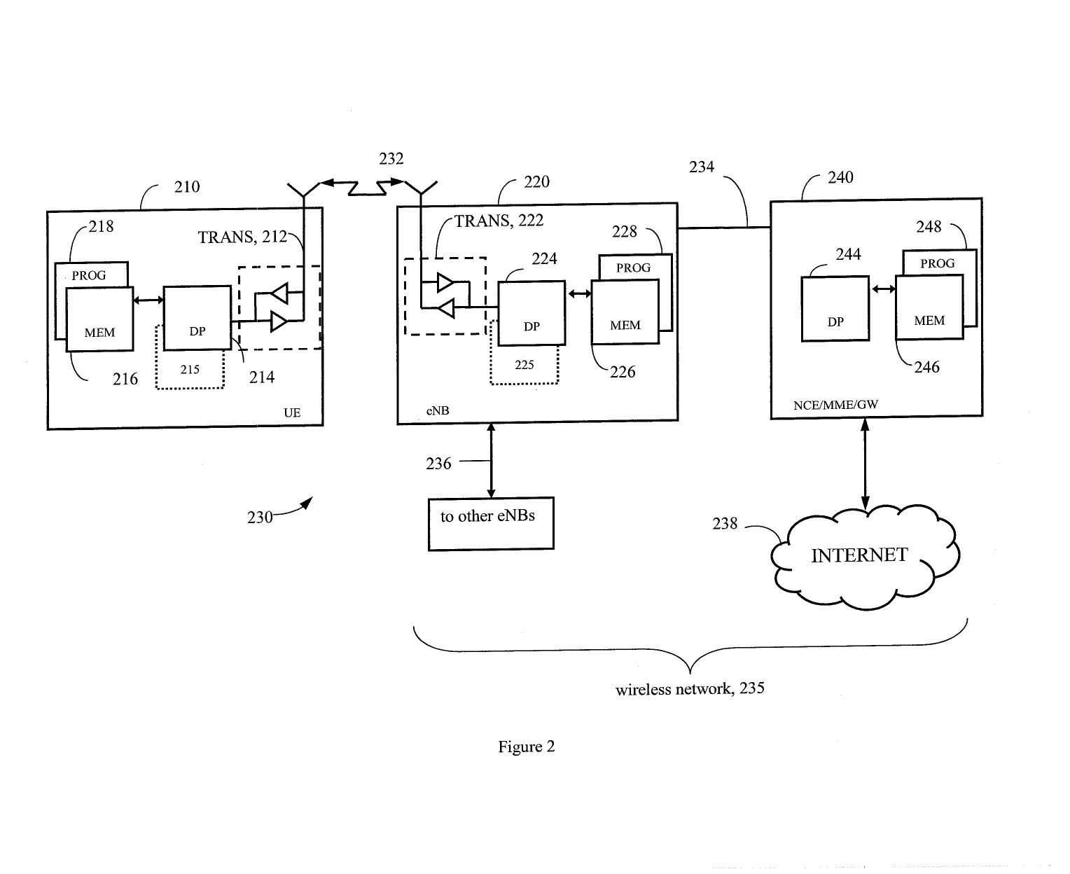

Before describing in further detail various exemplary embodiments of this invention, reference is made to FIG. 2 for illustrating a simplified block diagram of various electronic devices and apparatus that are suitable for use in practicing exemplary embodiments of this invention.

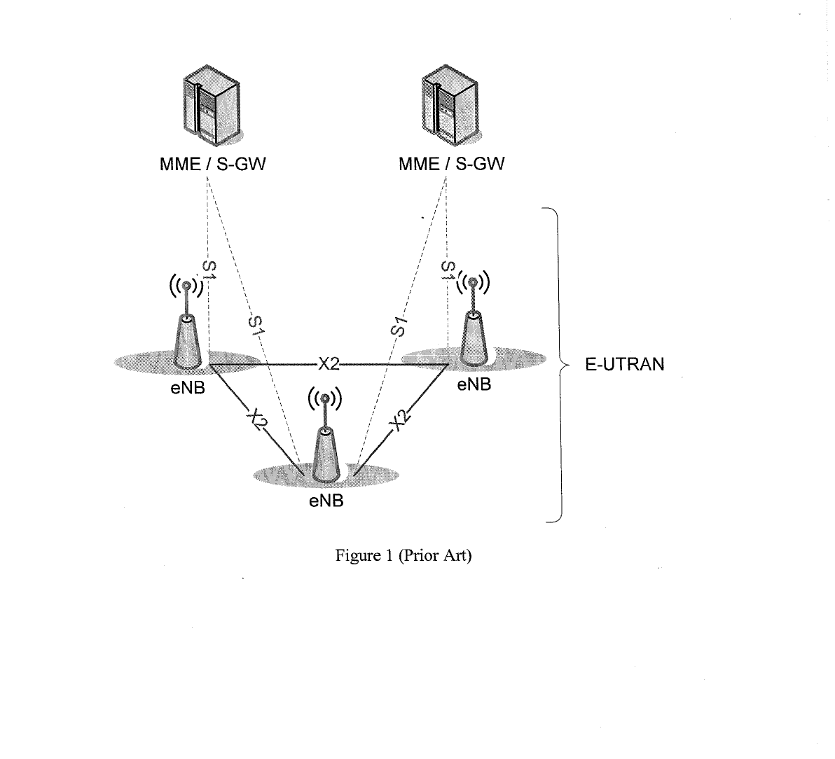

In the wireless system 230 of FIG. 2, a wireless network 235 is adapted for communication over a wireless link 232 with an apparatus, such as a mobile communication device which may be referred to as a UE 210, via a network access node/transmission point, such as a Node B (base station), and more specifically an eNB 220. The network 235 may include a network control element (NCE) 240 that may include the MME/SGW functionality shown in FIG. 1, and which provides connectivity with a network, such as a telephone network and/or a data communications network (e.g., the internet 238).

The UE 210 includes a controller, such as a computer or a data processor (DP) 214, a computer-readable memory medium embodied as a memory (MEM) 216 that stores a program of computer instructions (PROG) 218, and a suitable wireless interface, such as radio frequency (RF) transceiver 212, for bidirectional wireless communications with the eNB 220 via one or more antennas.

The eNB 220 also includes a controller, such as a computer or a data processor (DP) 224, a computer-readable memory medium embodied as a memory (MEM) 226 that stores a program of computer instructions (PROG) 228, and a suitable wireless interface, such as RF transceiver 222, for communication with the UE 210 via one or more antennas. The eNB 220 is coupled via a data/control path 234 to the NCE 240. The path 234 may be implemented as the S1 interface shown in FIG. 1. The eNB 220 may also be coupled to another eNB via data/control path 236, which may be implemented as the X2 interface shown in FIG. 1.

The NCE 240 includes a controller, such as a computer or a data processor (DP) 244, a computer-readable memory medium embodied as a memory (MEM) 246 that stores a program of computer instructions (PROG) 248.

At least one of the PROGs 218, 228 and 248 is assumed to include program instructions that, when executed by the associated DP, enable the device to operate in accordance with exemplary embodiments of this invention, as will be discussed below in greater detail.

That is, various exemplary embodiments of this invention may be implemented at least in part by computer software executable by the DP 214 of the UE 210; by the DP 224 of the eNB 220; and/or by the DP 244 of the NCE 240, or by hardware, or by a combination of software and hardware (and firmware).

The UE 210 and the eNB 220 may also include dedicated processors, for example CSI reporting processor 215 and CSI receiving processor 225.

In general, the various embodiments of the UE 210 can include, but are not limited to, cellular telephones, tablets having wireless communication capabilities, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 216, 226 and 246 may be of any type suitable to the local technical environment and may be implemented using any suitable data storage technology, such as semiconductor based memory devices, flash memory, magnetic memory devices and systems, optical memory devices and systems, fixed memory and removable memory. The DPs 214, 224 and 244 may be of any type suitable to the local technical environment, and may include one or more of general purpose computers, special purpose computers, microprocessors, digital signal processors (DSPs) and processors based on a multicore processor architecture, as non-limiting examples. The wireless interfaces (e.g., RF transceivers 212 and 222) may be of any type suitable to the local technical environment and may be implemented using any suitable communication technology such as individual transmitters, receivers, transceivers or a combination of such components.

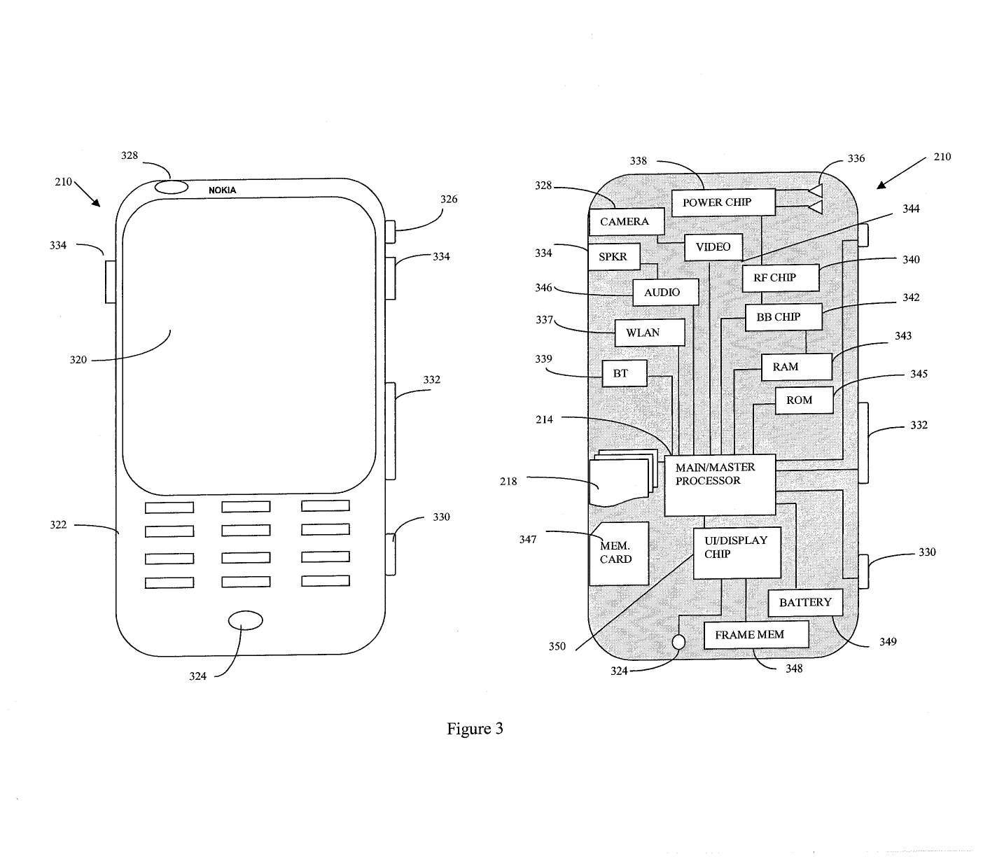

FIG. 3 illustrates further detail of an exemplary UE 210 in both plan view (left) and sectional view (right), and the invention may be embodied in one or some combination of those more function-specific components. At FIG. 3 the UE 210 has a graphical display interface 320 and a user interface 322 illustrated as a keypad but understood as also encompassing touch-screen technology at the graphical display interface 320 and voice-recognition technology received at the microphone 324. A power actuator 326 controls the device being turned on and off by the user. The exemplary UE 210 may have a camera 328 which is shown as being forward facing (e.g., for video calls) but may alternatively or additionally be rearward facing (e.g., for capturing images and video for local storage). The camera 328 is controlled by a shutter actuator 330 and optionally by a zoom actuator 332 which may alternatively function as a volume adjustment for the speaker(s) 334 when the camera 328 is not in an active mode.

Within the sectional view of FIG. 3 are seen multiple transmit/receive antennas 336 that are typically used for cellular communication. The antennas 336 may be multi-band for use with other radios in the UE 210. The operable ground plane for the antennas 336 is shown by shading as spanning the entire space enclosed by the UE 210 housing though in some embodiments the ground plane may be limited to a smaller area, such as disposed on a printed wiring board on which the power chip 338 is formed. The power chip 338 controls power amplification on the channels being transmitted and/or across the antennas that transmit simultaneously where spatial diversity is used, and amplifies the received signals. The power chip 338 outputs the amplified received signal to the radio-frequency (RF) chip 340 which demodulates and downconverts the signal for baseband processing. The baseband (BB) chip 342 detects the signal which is then converted to a bit-stream and finally decoded. Similar processing occurs in reverse for signals generated in the apparatus 210 and transmitted from it.

Signals to and from the camera 328 pass through an image/video processor 344 which encodes and decodes the various image frames. A separate audio processor 346 may also be present controlling signals to and from the speakers 334 and the microphone 324. The graphical display interface 320 is refreshed from a frame memory 348 as controlled by a user interface chip 350 which may process signals to and from the display interface 320 and/or additionally process user inputs from the keypad 322 and elsewhere.

Certain embodiments of the UE 210 may also include one or more secondary radios such as a wireless local area network radio WLAN 337 and a Bluetooth® radio 339, which may incorporate an antenna on-chip or be coupled to an off-chip antenna. Throughout the apparatus are various memories such as random access memory RAM 343, read only memory ROM 345, and in some embodiments removable memory such as the illustrated memory card 347. The various programs 218 are stored in one or more of these memories. All of these components within the UE 210 are normally powered by a portable power supply such as a battery 349.

Processors 338, 340, 342, 344, 346, 350, if embodied as separate entities in a UE 210 or eNB 220, may operate in a slave relationship to the main processor 214, 224, which may then be in a master relationship to them. Embodiments of this invention are most relevant to the BB chip 342, RF chip 340, DP 214 and CQI reporting processor 215, though it is noted that other embodiments need not be disposed there but may be disposed across various chips and memories as shown or disposed within another processor that combines some of the functions described above for FIG. 3. Any or all of these various processors of FIG. 3 access one or more of the various memories, which may be on-chip with the processor or separate therefrom. Similar function-specific components that are directed toward communications over a network broader than a piconet (e.g., components 336, 338, 340, 342-345 and 347) may also be disposed in exemplary embodiments of the access node 220, which may have an array of tower-mounted antennas rather than the two shown at FIG. 3.

Note that the various chips (e.g., 338, 340, 342, etc.) that were described above may be combined into a fewer number than described and, in a most compact case, may all be embodied physically within a single chip.

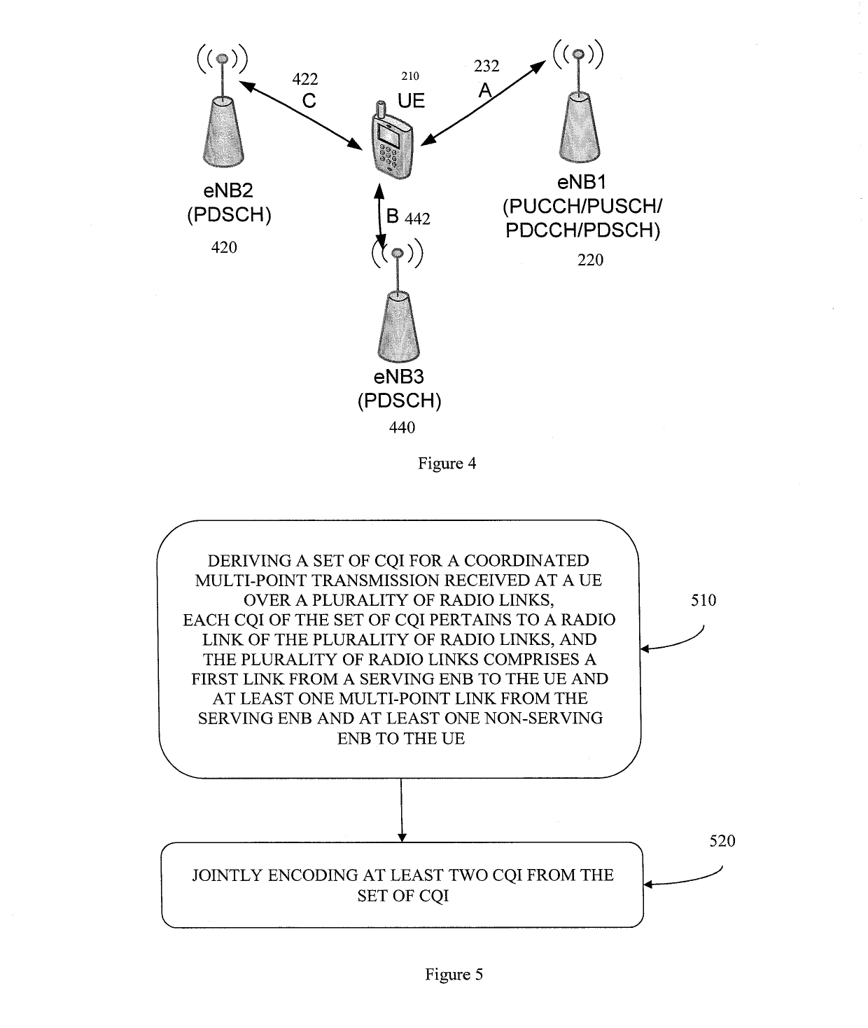

FIG. 4 shows a simplified block diagram of exemplary electronic devices that are suitable for use in practicing various exemplary embodiments of this invention. UE 210 is in a CoMP scenario. The UE 210 is attached to eNB1 220 and communicates with eNB1 220 for UL control (PUCCH), uplink data (PUSCH), DL control (PDCCH) channels. For CoMP transmission the UE 210 can receive a joint transmission (PDSCH) from any subset of eNB1 220, eNB2 420 and eNB3 440. Note that the labels eNB1, eNB2 and eNB3 as used in this diagram also applies to three geographically separated transmission points where a transmission point is defined as a co-located set of antennas. The transmission points may or may not be assigned the same cell-id. The transmission points may or may not belong to the same eNB.

A first radio link, radio link A, is between UE 210 and eNB1 220. There are two more radio links: radio link B: between UE 210 and eNB3 440, and radio link C: between UE 210 and eNB2 420. Each of these links may contain multiple transmit multiple receive antennas (for simplicity, assume each of them to be 2×2 channels). In addition to these links there is a multi-point link from eNB1 220, and eNB2 420 to UE 210 which creates a 4×2 channel. This multi-point link is referred to as AC. Similarly another multi-point link is from eNB1 220, eNB2 420, and eNB3 440 to UE 210 (referred to as ACB) and it creates a 6×2 channel.

As a non-limiting example, only three links are of interest—radio link A (a 2×2 channel), radio link AC (a 4×2 channel) and radio link ACB (a 6×2 channel). The UE 210 may measure and send CSI feedback for the 3 radio links A, AC and ACB to the eNB1 220. The techniques discussed below can be extend beyond 3 links.

Various exemplary embodiments in accordance with this invention are provided in the following:

Jointly Encoding RI Information:

For each of the radio links A, AC and ACB, the UE predicted rank may be either 1 or 2. Therefore, without any optimization three bits would be required to convey this rank information to the eNB1 220. However, the UE predicted rank for the link A is expected to be lower than or equal to that of the link AC which in turn is expected to be lower than that of the link ACB. This is expected since, for the purposes of rank determination, the transmit power assumption for link ACB is three times that of the transmit power of link A and the transmit power assumption for link AC is two times that of the transmit power of link A. In addition the interference power is the lowest for link ACB followed by that of link AC followed by that of link A. Therefore, the rank information possibilities that are of interest is limited to four cases. These cases are given by Table 1.

TABLE 1
Ranks of interest

| Case | Rank - Link A | Rank - Link AC | Rank - Link ACB |
|---|---|---|---|
| 1 | 1 | 1 | 1 |
| 2 | 1 | 1 | 2 |
| 3 | 1 | 2 | 2 |
| 4 | 2 | 2 | 2 |

Therefore by jointly coding the rank information across multiple links the information can be compressed to two bits (indicating which case) from three bits (indicating the rank of each link). Note that the same concept can be naturally extended to more than 3 radio links to reduce the payload information of rank reporting by joint encoding. Also note that eNB1, eNB2 and eNB3 as used in this embodiment also applies to three geographically separated transmission points where a transmission point is defined as a co-located set of antennas. The transmission points may or may not be assigned the same cell-id.

A rank report may typically be sent less often than CQI reports and many CQI reports can be conditioned on a single rank report. Therefore rank reports should be of high reliability and this especially motivates compression of payload sizes for rank reports.

Alternatively, the rank report can indicate a point in an ordered list of links that the rank changes from 1 to 2 or that no change occurs. The indication may assume a default rank such as rank 1. Using the previous example of Links A, AC and ACB, the list may be organized in order of “lowest expected rank first” creating the following list: 1) Link A, 2) Link AC and 3) Link ACB.

Therefore, an indication of no link where the rank changes coincides with Case 1 of

Table 1 where all links have the same rank (equal to the default of 1). Likewise, an indication of the first link (Link A) coincides with Case 4 where the rank increase from the default value to rank 2 for Link A.

The following table shows results from a system simulation that verifies that the UE predicted rank increases significantly for joint transmissions. In Table 2 an example of predicted rank at the UEs eligible for CoMP transmission (cell-edge UEs) for a 2×2 system with 0.5 λ spaced ULA antennas are shown. The simulation assumptions follow the 3GPP case-1 3D model.

TABLE 2
Average UE 210 predicted rank in system simulations

| | Average rank for | Average rank for | Average rank for |
|---|---|---|---|
| | transmission | joint transmission | joint transmission |
| Case | from single cell | from 2 cells | from 3 cells |
| 1 | 1 | 1.69 | 1.95 |

Jointly Coding Rank-2 COIs:

A potential rank-2 transmission scheme for JT CoMP is to transmit each layer from a different eNB. As an example, layer 1 may be transmitted from eNB 1 220 (over link A) and layer 2 may be transmitted from eNB2 420 (over link C). In such a scheme, the CQI for the two layers could be jointly coded using differential encoding. Note that eNB1, eNB2 as used in this embodiment also applies to two geographically separated transmission points where a transmission point is defined as a co-located set of antennas. The transmission points may or may not be assigned the same cell-id

Jointly Coding Multi-Cell Rank and Inter-Cell Phase Information:

Inter-cell phase information may be used for co-phasing transmission from multiple transmission points. Feedback of inter-cell phase information may be performed using PMI from inter-cell codebooks. Multi-cell rank may be jointly encoded with inter-cell PMI to reduce the payload size of feedback reporting. Inter-cell PMI may be sub-sampled for such joint-encoding. Note that this embodiment is also applicable to feedback of inter-point CSI and multi-point rank.

Jointly Coding CQI Information:

The SINR experienced by a UE 210 (e.g., by preprocessing the average at the receive antennas) is likely to increase from link A to link AC and again to link ACB. In addition, the increase in SINR slows down as more interferers are subtracted out. Therefore, joint encoding of CQI across multiple links may be performed using techniques such as differential encoding, for example, for transmit diversity CQI feedback with SRS.

Based on the foregoing it should be apparent that the exemplary embodiments of this invention provide a method, apparatus and computer program(s) to reduce feedback overhead for CoMP operation.

FIG. 5 is a logic flow diagram that illustrates the operation of a method, and a result of execution of computer program instructions, in accordance with the exemplary embodiments of this invention. In accordance with these exemplary embodiments a method performs, at Block 510, a step of deriving a set of CQI for a coordinated multi-point transmission received at a UE over a plurality of radio links. Each CQI of the set of CQI pertains to a radio link of the plurality of radio links The plurality of radio links comprises a first link from a serving eNB to the UE and at least one multi-point link from the serving eNB and at least one non-serving eNB to the UE. The method also performs, at Block 520, a step of jointly encoding at least two CQI from the set of CQI.

The various blocks shown in FIG. 5 may be viewed as method steps, and/or as operations that result from operation of computer program code, and/or as a plurality of coupled logic circuit elements constructed to carry out the associated function(s).

An exemplary embodiment in accordance with this invention provides a method to reduce feedback overhead for CoMP operation. The method includes deriving (e.g., by a processor) a set of CSI for a coordinated multi-point transmission received at a UE over a plurality of radio links. Each CSI of the set of CSI pertains to a radio link of the plurality of radio links. The plurality of radio links includes a first link from a serving eNB to the UE and at least one multi-point link from the serving eNB and at least one non-serving eNB to the UE. The method also includes jointly encoding (e.g., by a processor) at least two CSI from the set of CSI.

In a further exemplary embodiment of the method above, the method also includes reporting, to a serving eNB for the UE, the jointly encoded at least two CSI using UL physical channels.

In an additional exemplary embodiment of any one of the methods above, the plurality of radio links also include a second link which is a multi-point link from the serving eNB and a first, non-serving eNB to the UE; and a third link which is a multi-point link from the serving eNB, the first, non-serving eNB and a second, non-serving eNB to the UE.

In a further exemplary embodiment of any one of the methods above, jointly encoding the at least two CSI includes jointly encoding an inter-cell PMI. Jointly encoding the inter-cell PMI may include sub-sampling the inter-cell PMI.

In an additional exemplary embodiment of any one of the methods above, jointly encoding the at least two CSI includes performing differential encoding.

In a further exemplary embodiment of any one of the methods above, jointly encoding the at least two CSI also includes jointly encoding rank information for each radio link in the plurality of radio links. The rank information may include an indication of a rank change in an ordered list of the plurality of radio links. The indication of the rank change may indicate a first radio link in the ordered list to have a rank different from a radio link immediately prior to the first radio link in the ordered list or a default rank. Alternatively, the indication of the rank change may indicate that all radio links in the ordered list to have a default rank.

In an additional exemplary embodiment of any one of the methods above, deriving the set of CSI includes receiving the coordinated multi-point transmission and determining the CSI based on the received coordinated multi-point transmission.

A further exemplary embodiment in accordance with this invention provides an apparatus to reduce feedback overhead for CoMP operation. The apparatus includes at least one processor; and at least one memory including computer program code. The at least one memory and the computer program code are configured to, with the at least one processor, cause the apparatus to perform actions. The actions include to derive a set of CSI for a coordinated multi-point transmission received at a UE over a plurality of radio links. Each CSI of the set of CSI pertains to a radio link of the plurality of radio links. The plurality of radio links includes a first link from a serving eNB to the UE and at least one multi-point link from the serving eNB and at least one non-serving eNB to the UE. The actions also include to jointly encode at least two CSI from the set of CSI.

In an additional exemplary embodiment of the apparatus above, the actions also include to report, to a serving eNB for the UE, the jointly encoded at least two CSI using UL physical channels.

In a further exemplary embodiment of any one of the apparatus above, the plurality of radio links also include a second link which is a multi-point link from the serving eNB and a first, non-serving eNB to the UE; and a third link which is a multi-point link from the serving eNB, the first, non-serving eNB and a second, non-serving eNB to the UE.

In an additional exemplary embodiment of any one of the apparatus above, jointly encoding the at least two CSI includes jointly encoding an inter-cell PMI. Jointly encoding the inter-cell PMI may include sub-sampling the inter-cell PMI.

In a further exemplary embodiment of any one of the apparatus above, jointly encoding the at least two CSI includes performing differential encoding.

In an additional exemplary embodiment of any one of the apparatus above, jointly encoding the at least two CSI also includes jointly encoding rank information for each radio link in the plurality of radio links. The rank information may include an indication of a rank change in an ordered list of the plurality of radio links. The indication of the rank change may indicate a first radio link in the ordered list to have a rank different from a radio link immediately prior to the first radio link in the ordered list or a default rank. Alternatively, the indication of the rank change may indicate that all radio links in the ordered list to have a default rank.

In a further exemplary embodiment of any one of the apparatus above, deriving the set of CSI includes receiving the coordinated multi-point transmission and determining the CSI based on the received coordinated multi-point transmission.

An additional exemplary embodiment in accordance with this invention provides a computer readable medium to reduce feedback overhead for CoMP operation. The computer readable medium is tangibly encoded with a computer program executable by a processor to perform actions. The actions include deriving a set of CSI for a coordinated multi-point transmission received at a UE over a plurality of radio links. Each CSI of the set of CSI pertains to a radio link of the plurality of radio links The plurality of radio links includes a first link from a serving eNB to the UE and at least one multi-point link from the serving eNB and at least one non-serving eNB to the UE. The actions also include jointly encoding at least two CSI from the set of CSI.

In a further exemplary embodiment of the computer readable medium above, the actions also include reporting, to a serving eNB for the UE, the jointly encoded at least two CSI using UL physical channels.

In an additional exemplary embodiment of any one of the computer readable media above, the plurality of radio links also include a second link which is a multi-point link from the serving eNB and a first, non-serving eNB to the UE; and a third link which is a multi-point link from the serving eNB, the first, non-serving eNB and a second, non-serving eNB to the UE.

In a further exemplary embodiment of any one of the computer readable media above, jointly encoding the at least two CSI includes jointly encoding an inter-cell PMI. Jointly encoding the inter-cell PMI may include sub-sampling the inter-cell PMI.

In an additional exemplary embodiment of any one of the computer readable media above, jointly encoding the at least two CSI includes performing differential encoding.

In a further exemplary embodiment of any one of the computer readable media above, jointly encoding the at least two CSI also includes jointly encoding rank information for each radio link in the plurality of radio links. The rank information may include an indication of a rank change in an ordered list of the plurality of radio links. The indication of the rank change may indicate a first radio link in the ordered list to have a rank different from a radio link immediately prior to the first radio link in the ordered list or a default rank. Alternatively, the indication of the rank change may indicate that all radio links in the ordered list to have a default rank.

In an additional exemplary embodiment of any one of the computer readable media above, deriving the set of CSI includes receiving the coordinated multi-point transmission and determining the CSI based on the received coordinated multi-point transmission.

In a further exemplary embodiment of any one of the computer readable media above, the computer readable medium is a non-transitory computer readable medium (for example, a CD-ROM, RAM, flash memory, etc.).

An additional exemplary embodiment in accordance with this invention provides an apparatus to reduce feedback overhead for CoMP operation. The apparatus includes means for deriving (e.g., a processor) a set of CSI for a coordinated multi-point transmission received at a UE over a plurality of radio links. Each CSI of the set of CSI pertains to a radio link of the plurality of radio links. The plurality of radio links includes a first link from a serving eNB to the UE and at least one multi-point link from the serving eNB and at least one non-serving eNB to the UE. The apparatus also includes means for jointly encoding (e.g., a processor) at least two CSI from the set of CSI.

In a further exemplary embodiment of the apparatus above, the apparatus also includes means for reporting, to a serving eNB for the UE, the jointly encoded at least two CSI using UL physical channels.

In an additional exemplary embodiment of any one of the apparatus above, the plurality of radio links also include a second link which is a multi-point link from the serving eNB and a first, non-serving eNB to the UE; and a third link which is a multi-point link from the serving eNB, the first, non-serving eNB and a second, non-serving eNB to the UE.

In a further exemplary embodiment of any one of the apparatus above, where the jointly encoding means includes means for jointly encoding an inter-cell PMI. The inter-cell PMI jointly encoding means may include means for sub-sampling the inter-cell PMI.

In an additional exemplary embodiment of any one of the apparatus above, the jointly encoding means includes means for performing differential encoding.

In a further exemplary embodiment of any one of the apparatus above, the jointly encoding means includes means for jointly encoding rank information for each radio link in the plurality of radio links. The rank information may include an indication of a rank change in an ordered list of the plurality of radio links. The indication of the rank change may indicate a first radio link in the ordered list to have a rank different from a radio link immediately prior to the first radio link in the ordered list or a default rank. Alternatively, the indication of the rank change may indicate that all radio links in the ordered list to have a default rank.

In an additional exemplary embodiment of any one of the apparatus above, the deriving means includes means for receiving the coordinated multi-point transmission and means for determining the CSI based on the received coordinated multi-point transmission.

In general, the various exemplary embodiments may be implemented in hardware or special purpose circuits, software, logic or any combination thereof For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the E-UTRAN (UTRAN-LTE) system, it should be appreciated that the exemplary embodiments of this invention are not limited for use with only this one particular type of wireless communication system, and that they may be used to advantage in other wireless communication systems such as for example (UTRAN).

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names assigned to different channels (e.g., PUCCH, PUSCH, PDSCH, etc.) are not intended to be limiting in any respect, as these various channels may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
deriving a set of channel state information for a coordinated multi-point transmission received at a user equipment over a plurality of radio links,
where each channel state information of the set of channel state information pertains to a radio link of the plurality of radio links, and
where the plurality of radio links comprises a first link from a serving transmission point and at least one multi-point link from at least one non-serving transmission point to the user equipment; and
jointly encoding at least two channel state information from the set of channel state information.

2. The method of claim 1, further comprising reporting, to a serving transmission point from the user equipment, the jointly encoded at least two channel state information using uplink physical channels.

3. The method of claim 1, where the plurality of radio links further comprises:
a second link which is a multi-point link from the serving transmission point and a first, non-serving transmission point to the user equipment; and
a third link which is a multi-point link from the serving transmission point, the first, non-serving transmission point and a second, non-serving transmission point to the user equipment.

4. The method of claim 1, where jointly encoding the at least two channel state information comprises jointly encoding an inter-point precoding matrix indicator.

5. The method of claim 4, where jointly encoding the inter-point precoding matrix indicator comprises sub-sampling the inter-point precoding matrix indicator.

6. The method of claim 1, where jointly encoding the at least two channel state information comprises jointly encoding a rank indicator.

7. The method of claim 1, where jointly encoding the at least two channel state information comprises jointly encoding a channel quality indicator.

8. The method of claim 1, where jointly encoding the at least two channel state information comprises performing differential encoding.

9. The method of claim 1, where jointly encoding the at least two channel state information further comprises jointly encoding rank information for each radio link in the plurality of radio links.

10. The method of claim 9, where the rank information comprises an indication of a rank change in an ordered list of the plurality of radio links.

11. The method of claim 10, where the indication of the rank change indicates a first radio link in the ordered list to have a rank different from one of: a radio link immediately prior to the first radio link in the ordered list and a default rank.

12. The method of claim 1, where deriving the set of channel state information comprises:
receiving reference signals for at least one coordinated multi-point measurement and
determining the channel state information based on the received reference signals for the at least one coordinated multi-point measurement.

13. An apparatus, comprising at least one processor; and at least one memory including computer program code, the at least one memory and the computer program code configured to, with the at least one processor, cause the apparatus to perform at least the following:
to derive a set of channel state information for a coordinated multi-point transmission received at a user equipment over a plurality of radio links,
where each channel state information of the set of channel state information pertains to a radio link of the plurality of radio links, and
where the plurality of radio links comprises a first link from a serving transmission point and at least one multi-point link from at least one non-serving transmission point to the user equipment; and
to jointly encode at least two channel state information from the set of channel state information.

14. The apparatus of claim 13, where, when jointly encoding the at least two channel state information, the at least one memory and the computer program code are further configured to cause the apparatus to jointly encode rank information for each radio link in the plurality of radio links, where the rank information comprises an indication of a rank change in an ordered list of the plurality of radio links.

15. The apparatus of claim 13, where, when deriving the set of channel state information, the at least one memory and the computer program code are further configured to cause the apparatus:
to receive reference signals for at least one coordinated multi-point measurement and
to determine the channel state information based on the received reference signals for the at least one coordinated multi-point measurement.

16. A computer readable medium tangibly encoded with a computer program executable by a processor to perform actions comprising:
deriving a set of channel state information for a coordinated multi-point transmission received at a user equipment over a plurality of radio links,
where each channel state information of the set of channel state information pertains to a radio link of the plurality of radio links, and
where the plurality of radio links comprises a first link from a serving transmission point and at least one multi-point link from at least one non-serving transmission point to the user equipment; and
jointly encoding at least two channel state information from the set of channel state information.

17. The computer readable medium of claim 16, where jointly encoding the at least two channel state information further comprises jointly encoding rank information for each radio link in the plurality of radio links, where the rank information comprises an indication of a rank change in an ordered list of the plurality of radio links.

18. The computer readable medium of claim 16, where deriving the set of channel state information comprises:
receiving the reference signals for at least one coordinated multi-point measurement and
determining the channel state information based on the received reference signals for the at least one coordinated multi-point measurement.

19. An apparatus, comprising:
means for deriving a set of channel state information for a coordinated multi-point transmission received at a user equipment over a plurality of radio links,
where each channel state information of the set of channel state information pertains to a radio link of the plurality of radio links, and
where the plurality of radio links comprises a first link from a serving transmission point and at least one multi-point link from at least one non-serving transmission point to the user equipment; and
means for jointly encoding at least two channel state information from the set of channel state information.

20. The apparatus of claim 19, where the jointly encoding means comprises means for jointly encoding rank information for each radio link in the plurality of radio links, where the rank information comprises an indication of a rank change in an ordered list of the plurality of radio links.
